(19) United States
(12) Patent Application Publication
(10) Pub. No.: US 2004/0252679 A1
(43) Pub. Date: Dec. 16, 2004

(54) Stored voice message control extensions

(76) Inventors: Tim Williams, Danville, CA (US); Daniel A. Brookshire, Manor, TX (US); Dirk D. Eide, Leavenworth, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/423,061

(22) Filed: Apr. 24, 2003

Related U.S. Application Data
(63) Continuation-in-part of application No. 10/084,413, filed on Feb. 26, 2002.
(63) Continuation-in-part of application No. 10/112,303, filed on Mar. 29, 2002.
(60) Provisional application No. 60/375,677, filed on Apr. 26, 2002.

(51) Int. Cl. H04L 12/66

(52) U.S. Cl. 370/356

(57) ABSTRACT

A method and apparatus for performing voice message control is described. In one embodiment, the method comprises recognizing at least one recipient and a subject matter of one or more audio files stored in a storage facility, generating a text message representing the subject matter of the one or more audio files, and transmitting the text message to the at least one identified recipient over a packet data network channel without transmitting the contents of the one or more audio files.

### RELATED APPLICATIONS

This application claims the benefit of U.S. Provisional Application No. 60/375,677, filed Apr. 26, 2002, which is hereby incorporated by reference.

This application is a continuation-in-part (CIP) of U.S. patent application Ser. No. 10/084,413, filed on Feb. 26, 2002 and a CIP of U.S. patent application Ser. No. 10/112,303, filed on Mar. 29, 2002, which is a CIP of U.S. patent application Ser. No. 10/084,413, filed on Feb. 26, 2002. The above identified applications are hereby incorporated by reference.

### FIELD OF THE INVENTION

The present invention relates to the field of communications; more particularly, the present invention relates to accessing stored voice messages for subsequent manipulation and/or presentation.

### BACKGROUND OF THE INVENTION

There are a number of technologies available for transferring text and voice information. For example, to transfer text information in real time, NetMeeting from Microsoft of Redmond, Washington may be used. Similarly, if non-real time text transfer is desired, but relatively quick communication in the approximate one to fifteen minute time frame is desired, then AOL Instant Messenger (AIM), Short Messaging Service over Cellular Networks (SMS) or paging (e.g., two-way paging, one-way paging) may be used.

If a longer period of delay is allowable, text information may be transferred using electronic mail (email) systems. Email systems always have to store a message and then have a recipient retrieve the message to access it. Also, there is no way to know if an email message from a specific person has been received until the email messages are retrieved. One email system disclosed in (Etrieve cite to be added) describes attaching a voice file to an email. The user receives notification of the email by a SMS messaging system, and when the email is responded to, the system retrieves the voice file from memory and plays back the voice file over a circuit switch voice channel. Therefore, even in this email system, it is still required in this system that the message (the voice file) requires the user to actively retrieve the voice file from a storage facility.

Long term archival of text messages is a common occurrence and may be performed by using, for example, CD-ROM. Long term archival of voice messages, however, is not performed today with the capability to effectively index the messages.

Many systems exist for transferring voice information. For example, in real-time voice transfer, a phone, wired or wireless, may be used. One of the wireless cellular carrier networks, Nextel, currently markets a cellular phone based system that includes two-way radio functionality that permits the user, by pressing a button, to use the phone as a two-way radio to transfer voice to preassigned individuals. Similarly, with respect to voice, there are a number of stores and retrieve options for transferring voice such as, for example, voice mail. Also, with respect to archiving, there are a number of ways, such as CD-ROMs and tapes, that may be used to record voice files for archival purposes. However, with respect to the communication window of one to fifteen minutes, there seems to be no counterpoint in voice transfer technology that matches or equates to that of instant messaging, SMS or paging used in the transfer of text messages.

### SUMMARY OF THE DESCRIPTION

A method and apparatus for performing voice message control is described. In one embodiment, the method comprises recognizing at least one recipient and a subject matter of one or more audio files stored in a storage facility, generating a text message representing the subject matter of the one or more audio files, and transmitting the text message to the at least one identified recipient over a packet data network channel without transmitting the contents of the one or more audio files.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 illustrates an exemplary architecture of a communication system.

FIG. 2 is a flow diagram of one embodiment of a process performed by a mobile device (or other device with communication capabilities) in a network environment.

FIG. 3 is one embodiment of a mobile device.

FIG. 4 is a flow diagram of one embodiment of a process performed by a mobile device to process menu items.

FIG. 5 is a flow diagram of one embodiment of a process for routing a voice message.

FIG. 6 is a flow diagram of one embodiment of the process to identify an operation and specified recipient(s).

FIG. 7 illustrates an exemplary architecture for accessing stored voice messages.

FIG. 8 is a flow diagram of one embodiment of the voice mail control process described above.

FIG. 9 is a block diagram of one embodiment of a connectivity server.

FIG. 10 is a block diagram of one embodiment of a connectivity server.

FIG. 11 is a block diagram of one embodiment of a telephony interface.

FIG. 12 is a flow diagram of one embodiment of a process for voice message management.

FIG. 13 is a block diagram of one embodiment of a voice message management system.

FIG. 14 is a flow diagram of one embodiment of a process for voice message management.

FIG. 15 is a flow diagram of one embodiment of a process for voice message management.

FIG. 16 is a flow diagram of one embodiment of a process for voice message management.

### DETAILED DESCRIPTION

A communication system is described in which a user of a mobile device, such as a cellular phone, to put the phone in a particular mode, such as by pressing a button on the phone, and causing an audio (voice) message to be queued, sent over a packet data network channel and routed to a recipient or location specified in the message according to a pre-specified routing mechanism. The routing mechanism may cause the message to be forwarded to, for example, another cellular phone in the same carrier network, pager or other mobile device in a different carrier network, a telephone that is part of a Plain Old Telephone System (POTS), a personal digital assistant (PDA), a VoP terminal, or any voice capable device communicating via wireless LAN technologies.

A communication system is described that provides for the storage and retrieval by program control of voice messages contained within industry standard voice mail systems. Once the voice messages are contained within a program controlled environment, they may be manipulated, format converted, compressed, transferred into audio on any one of a variety of communication media, stored, indexed and/or deleted.

In the following description, numerous details are set forth to provide a thorough understanding of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

An Exemplary Architecture

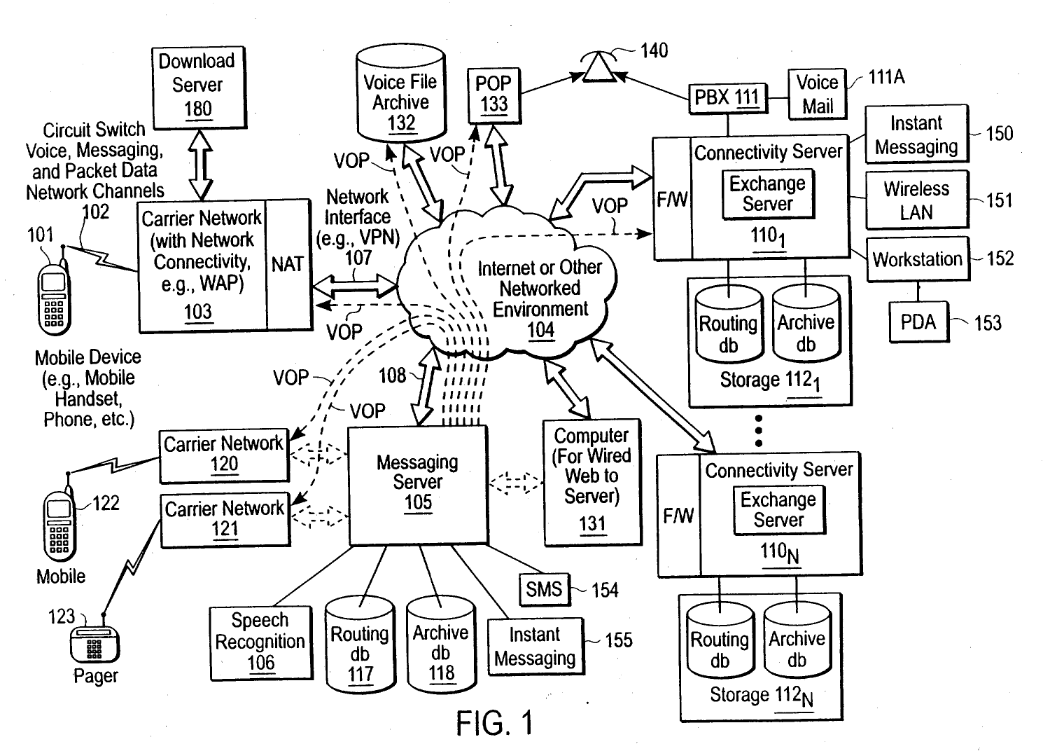

FIG. 1 illustrates an exemplary architecture of a communication system. Referring to FIG. 1, the voice messaging communication system may include a mobile device 101 (e.g., mobile handset, phone, computer, personal digital assistant (PDA), etc.) that is communicably coupled to a wireless carrier's network 103 via circuit switched voice, messaging and packet data network channels 102. In one embodiment, the circuit switched voice channel is a channel which primarily carries digitized and compressed voice represented as bits of information placed into a regular time slot on the channel (a wireline telephony example of a similar structure is that of a single voice channel, DSO, within a the T1 or DS1 carrier, a cellular phone network example is the voice channel of a GSM phone), the messaging channel is used to primarily provide a call setup and roaming function for controlling the operation of mobile device 101, and the packet data network channel is a channel which provides packet data communications capability. In one embodiment, this packet data communications capability has a data rate of between 115 kb/s and 2 Mb/s. In one embodiment, the packet data channel is also used to communicate control information. In such a case, the packet data network channel operates as a digital channel. Alternatively, TDM channels may be transferred as well.

Carrier network 103 is coupled to the network interface (e.g., the VPN) 107 to Internet (or other network environment) 104. In one embodiment, carrier network 103 is WAP-enabled to allow Internet connectivity of a mobile device. In this way, WAP and packet data channels can co-exist. A download server 180 may be coupled to carrier network 103. Download server 180 may be used to download software to mobile device 101. This software may comprise a Java 2 Mobile Execution (J2ME) program or other programs that mobile device 101 may use to process the voice messages and transmit them onto the packet data network channel.

Messaging server 105 is coupled to network environment 104 via network interface 108. One or more additional network carrier networks, such as carrier networks 120 and 121, providing access to mobile devices 122 and pager 123, respectively, are also communicably coupled to messaging server 105. Messaging server 105 may be communicably coupled to carrier networks 120 and 121 through network environment 104. This may be by Voice Over Packet communications (VOP). A version of VOP communications is known as VoIP. Such communications may be used for communication between messaging server 105 and carrier network 103 as well. In an alternative embodiment, messaging server 105 and one or more of carrier networks 120 and 121 may be co-located. In such a case, communication may occur directly between the parties, as opposed to going through network environment 104.

One or more connectivity servers 110₁-110_{N} may be coupled to network environment 104. Messaging server 105 communicates with each of connectivity servers 110₁-110_{N} through network environment 104. This communication may be by VOP. In one embodiment, each connectivity server 110₁-110_{N} is coupled to an exchange server (e.g., Microsoft Exchange Server) and also is coupled to storage 112, which may include one or more databases, including a routing database and an archival database. These databases may be stored in the same memory or separate memories.

Each connectivity server 110₁-110_{N} may be coupled to a PBX, such as PBX 111, which may include a voice mail system, to provide access to telephones within the PBX as well as circuit switched access to the PSTN or packet based access to other voice services, such as telephone 140. Note that some embodiments of connectivity servers may or may not include all the features shown in FIG. 1 and described herein.

Connectivity server 110, is shown having access to an instant messaging unit 150 to use instant messaging, a wireless local area network (LAN) to communicate with a device accessible thereby, and a workstation 152 to contact PDA 153.

A point of presence (POP) 133 is also coupled to network environment 104 to provide access via Voice Over Packet (VOP) to telephones, such as telephone 140.

A voice file archive 132 is also coupled to the network environment 104 to archive voice messages. In one embodiment, communication between messaging server 105 and voice file archival is by VOP.

Messaging server 105 is coupled to SMS functional unit 154 and instant messaging functional unit 155, which provide access to SMS and instant messaging capabilities, respectively, to messaging server 105.

Messaging server 105 is also coupled to speech recognition processor 106, and optionally coupled to computer system 131, routing database 117, and an archival database 118. Computer system 131 may be coupled to messaging server 105 directly or through one or more intermediaries, i.e., such as network environment 104 (via, for example, web access) to set up routing information for individuals to be stored in routing database 117 or to access and manage (e.g., delete) voice messages stored in archival database 118.

Note that the term “server” as used herein is not limited to a single computer system executing software and may comprise one or more software processes running on one or more different computer systems.

In one embodiment, routing database 117 stores a routing address book of routing information specifying the communication mechanism that is to be used by messaging server 105 to forward a voice message during specific times of each day, week, month and/or year. For example, for one individual, the routing information may indicate that from 8:00-10:00 a.m. all voice messages should be forwarded to their regular land-line telephone via a wired line, (e.g., telephone 140 via PBX 111 accessed through corporate server 110 or POP 133 ), from 10:00 a.m. to 5:00 p.m. all voice messages should be forwarded to their cell phone via a specified carrier network (e.g., mobile 122 via carrier network 120 ), from 5:00 p.m.-7:00 p.m. all voice messages should be forwarded to their pager via a specified carrier network (e.g., pager 123 via carrier network 121 ), and from 7:00 p.m. to 8:00 a.m. all voice messages should be forwarded to archival database 118 (or voice message archive 132 ) for storage as a voice mail message for later retrieval. This routing information may be part of each user profile maintained in the system.

In one embodiment, the communication architecture described in FIG. 1 enables the user of a mobile device, such as mobile device 101, to perform one or more of the following types of communications: 1) an interpersonal communication (send to another person); 2) a group communication (send to a group of people, such as an engineering work group); and 3) memo to self; 4) interactions with computers. Examples of interaction with computers include access to scheduling and calendaring information that may be contained within a user's Outlook (e.g., Microsoft Outlook) program on the user's desktop computer or within the user's PDA. Another example of interaction with computers is allowing access to the user's account on a voice mail system for the purposes of control, message retrieval, and/or message storage.

Interpersonal Communications

To perform an interpersonal communication to communicate with another individual in a store and forward manner, a user of mobile device 101 activates mobile device 101. Activating mobile device 101 may comprise pressing a button (e.g., key on a keypad, soft button (e.g., touch screen touched by a finger)) or using some other selection mechanism (e.g., stylus, mouse click, speech recognition on the handset, etc.) on mobile device 101. Activating mobile device 101 may comprise receiving an authorization from a biometric device (e.g., a speech recognizer to identify an individual by their voice).

In response to this activation (e.g., selection), mobile device 101 causes utterances (a voice message) to be queued and sent as a voice file from mobile device 101 via a packet data channel and forwarded to another individual. In response to the button being pressed on mobile device 101, a voice message may be created and sent over packet data channel 102 to carrier network 103. Thus, pressing the button on mobile device 101 activates the packet data channel without dialing a phone number and mobile device 101 is able to send a voice message to another without having to perform any phone number lookup.

Carrier network 103 separates the packets received from mobile device 102 and sends them to messaging server 105. In one embodiment, a firewall of carrier network 103 normally allows unimpeded access to Internet 104. In one embodiment, carrier network 103 uses a virtual private network (VPN) connection (i.e., a port on the firewall of carrier network 103) to Internet 104 to send the packetized voice message received over the data packet network channel from mobile device 101. Carrier network 103 may perform a network address translation (NAT) to identify a packet stream from mobile device 101 as one to be forwarded to Internet 104.

Messaging server 105 determines actions to take with the voice message based on its contents. For example, a user of mobile device 101 may record a voice message such as “Call Mary engineering meeting is canceled.” In response to receiving this message, messaging server 105 determines that a call is to be made to a specified recipient named Mary.: In order to complete this call, messaging server 105 is able to determine who the specified recipient(s) (e.g., Mary in this example) is and how to contact the specified recipient(s).

Messaging server 105 may use speech recognition on the voice message to identify names of individuals contained in the message as well as one or more commands. In one embodiment, messaging server 105 knows the portion of the voice messages that are command words (or phrases) and names of specified recipients by constraining the command words (or phrases) to a predetermined set and constraining the location in the voice message of both the command words and named recipients (or entity). More specifically, constraining the context of the sentence, for example the first word is always one of a small set of words (e.g., call, schedule, forward, memo) followed by the recipient name as it is contained within the routing address book. The commands are identified by comparing recognized words with a list of preselected command words and individual words are parsed by the intervening silence.

In one embodiment, if the first word is not one of the predefined set of words, messaging server 105 saves the voice message and sends a menu list to the user of what actions are to be taken, e.g., call, schedule, forward, memo, and a list of recipients from the address book, if that is necessary. In another embodiment, if the speech recognizer cannot adequately determine the contents of the voice message, the voice message is routed to a human operator who performs the speech-to-text processing by listening to the message and transcribing it into text. The voice message may have digital signal processing performed on it prior to being routed to the human operator. An example of which is the reduction of background noise. Thus, messaging server 105 may reflect back to mobile device 101 a textual list of commands and/or recipients in response to the voice message if it was not clear after performing speech recognition who the specified recipient(s) is or the command(s) that is to be performed as a prompt to the user to clarify the desired command and/or recipient(s), if any. In such a case, messaging server 105 generates a text message with a command recognizable to the mobile device and sends the text message to carrier network 103, which forwards the message to mobile device 101. The text message may be sent to mobile device 101 over the messaging or packet channel. In one embodiment, the prompt can come either through WAP (packet channel), which causes the prompt to be presented on a static web page like browser interface, or in alternative embodiments, it can come through the packet channel to a JAVA or other similar program running on mobile device 101 that displays the prompt (e.g., menu) on a display of mobile device 101.

Messaging server 105 determines how to route the voice message to the specified recipient(s) by locating routing information for the specified recipient(s). In one embodiment, messaging server 105 accesses a local database, such as routing database 117, using the name of the specified recipient(s), to obtain the necessary routing information from a previously entered profile as specified by the user.

In an alternative embodiment, messaging server 105 locates the routing information for the specified recipient(s) by contacting one of the corporate servers. The corporate server maintains routing information for a number of individuals in a database. Messaging server 105 sends the name(s) of the specified recipient(s) and the sender to the corporate server, which accesses its database and provides the requested routing information. In one embodiment, the corporate server may use Microsoft Exchange Server or other similar functioning server to identify the routing information for the specified recipient(s) in response to receiving the name(s) of the specified recipient.

Note that if more than one corporate server-is maintaining routing information, messaging server 105 identifies the corporate server that is storing the routing information for the specified recipient(s) it needs based on a unique identifier associated with the mobile device sending the voice message which identifies the user who is originating the message. More specifically,;in one embodiment, each user is assigned a unique identifier and this unique identifier is included in the packet header of the packets containing the voice message that is sent on the packet data network channel. When messaging server 105 receives the packets, it obtains this unique identifier and accesses a local memory that is able to associate a corporate server with the unique identifier. In one embodiment, the local memory includes a listing of all unique identifiers and their associated corporate server. In an alternative embodiment, a hash table is used and the unique identifier is used to hash to a value indicative of the corporate server associated with that unique identifier.

Thus, messaging server 105 determines how to route the voice file message to the recipient(s) specified in the voice message and routes the voice file to the specified recipient(s). Thus, the voice messages route themselves in that the information needed to determine where to route the messages is determined using the content of the voice message. For example, the determination of how to route the voice file to Mary may be based on local information, such as the information stored in the routing database 117, to which messaging server 105 has access, or may be determined by accessing another server, such as one of connectivity servers 110₁-110_{N}. In the latter case, messaging server 105 would forward the name Mary to the corporate server, which would access a routing database, such as a routing database in storage 112₁ and provide information indicative of how to route a message to Mary back to messaging server 105. Using that information, messaging server 105 routes the message to Mary.

The routing information may indicate that any voice message is to be routed to the specified recipient by way of another mobile device accessible via carrier network 103. In such a case, upon determining the specified recipient and the routing information specifying a mobile device in the coverage area of the carrier network 103, messaging server 105 sends a packetized stream through carrier network 103 via network environment 105, to be sent to the mobile device.

In one embodiment, messaging server 105 contacts the mobile device using the circuit switched channel in a typical fashion, such as by calling the mobile device. When the individual answers, messaging server 105 plays a voice prompt telling the individual that a voice message exists for the individual and asks whether the individual will like to hear the voice message. The individual may be instructed to indicate their desire to hear the message in one or more ways, such as, for example, by pressing a particular button on the mobile device, saying a particular phrase (which would be recognizable by messaging server 105), or selecting a menu item displayed on the phone. In response to the selection, messaging server 105 plays the message.

In an alternative embodiment, the packetized stream is sent to the mobile device via through carrier network 103 using the packet data network channel. In such a case, the mobile device includes functionality to play or review the voice message if sent via the packet data network channel. Such functionality includes a de-packetizer to depacketize the stream to retrieve the voice message and an audio player to operate in conjunction with any speaker of the mobile device to generate audio signals to drive the speaker to play the voice message.

In one embodiment, voice mail-like controls of play, skip, fast forward, backup, delete, and reply will be available to the user at the time of reviewing the voice messages regardless of the delivery mechanism of packet channel or circuit switched channel.

If the routing information indicates that the specified recipient is at a POTS telephone or a PBX station set, such as telephone 140, messaging server 105 may route the voice message to telephone 140 using Voice Over Packet (VOP) to POP 133 and onto telephone 140, or may gain access to a corporate servers' PBX, such as PBX 111, and utilize the connectivity server 110₁ to initiate the call to telephone 140. In either case, messaging server 105 converts the packet data to analog voice to play the voice message.

If the routing information indicates that the specified recipient is on a mobile device of another carrier network, messaging server 105 may initiate a call to that other mobile device. For example, it specifies individuals at mobile phone 122, messaging server 105 may initiate the call through to carrier network 120 in order to place the call to mobile device 122 in the same way the call is made and the message is delivered as described above. That is, if a packet data network channel is not being used, messaging server 105 may convert the voice message to analog speech using the an appropriate converter and send a call to mobile device 122 using a circuit switch voice channel. Further, alternatively, messaging server 105 may send use a voice-to-text converter to generate text messages and send it to the mobile device via a messaging or packet channel, if such a messaging or packet channel is available.

If the specified recipient is on a device such as (one-way or two-way) pager 123, messaging server 105 converts the voice file to text and sends the text as a text message to the pager through its carrier network (e.g., pager 123 through carrier network 121).

Note that, in one embodiment, if an individual declines to receive a voice message after being prompted regarding its availability or does not respond to the call from messaging server 105, messaging server 105 may store the message into the individual's voice message storage archival facility, such as voice mail archive 132, or has the message played into a voice mail system, such as voice mail 111A by connectivity server 110₁. This connection with the voice mail system 111a is performed by the connectivity server. One method to perform this operation is for the connectivity server to place a phone call (circuit switched or VOP) into the PBX essentially dialing phone number corresponding to the user's voice mail box extension. In one embodiment, when a voice message is archived, the voice message is tagged with the date and time of the voice message, as well as the sender and specified recipient(s) of the voice message and message length and priority.

Group Communications

Group communications may be performed in the same manner as interpersonal communications except that the specified recipient of the voice message received by messaging server 105 comprises the name of a group or a multiplicity of recipients. In such a case, in one embodiment, routing server 105 or corporate server 105 includes a database listing created by the sender or surrogate of each individual in the group and obtains the routing information for each of the individuals in the group. Using the routing information for each of the individuals in the group, messaging server 105 forwards the voice message to each individual as individual communications. Thus, if the routing information in each of the specified recipients' profiles is to multiple devices, including different types of devices (e.g., cellular phone, pager, landline telephones, etc.), messaging server 105 routes the message to each device as a separate communication.

Alternatively, messaging server 105 uses the unique identifier in the packet header to identify a corporate server and sends the group name to the corporate server. In response, the corporate server sends the routing information for each of the members in the group to messaging server 105 so that messaging server 105 is able to route the voice file to the individuals in the group correctly.

Memos

The architecture may enable an individual to send himself or herself a memo. In such a case, the user of a mobile device, such as mobile device 101, presses a button or other selection mechanism on their mobile device to record a voice message with an indication that the voice message is a memo. This voice message is then packetized and sent to messaging server 105, which identifies it as a memo and stores the memo in an archive (e.g., archive 132, archive 118, etc.).

Memos may be retrieved by the individual in the same way as a voice message or the memo may be scheduled to return to the user at a specific time and date. In one embodiment, a browser interface may be used to access and review messages, including memos. This browser interface allows the user to audio playback the message and/or has it converted to text and displayed.

Alternatively, individuals may forward memos to other people.

In one embodiment, messaging server 105 automatically creates an email to the mobile device user by converting the voice file to text and sending the email to the user via normal email facilities.

If an Outlook-based system is employed, a reminder or notification may be launched automatically from Outlook. This is performed by the connectivity server obtaining information from the user's Calendar or PIM (Personal Information Management) system (e.g., Microsoft Outlook) regarding the onset of a calendar or memo event. The connectivity server associates the event with a voice file and schedules a voice message to be transmitted to the user. The voice file can either be a prerecorded message or be created from the event itself via a text-to-speech system associated with or part of the messaging server.

Note that in alternative embodiments, the voice messaging described herein may be performed with a device that is not a mobile device. For example, the voice messaging may be performed with a PSTN phone. In such a case, the PSTN phone dials into messaging server 105 and leaves a message. Messaging server 105 processes the message in the same manner as if received from a mobile device.

Other Features of the Architecture

In one embodiment, messaging server 105 archives voice messages and other information for billing purposes. Such information may be archived using database 118 or voice message archive 132. Similarly, corporate server 110₁-110_{N} may include a portion of storage 112₁-112_{N}, respectively, for use as an archive.

In one embodiment, download server 112 enables over-the-air download of software modules, such as for example, J2ME, to reconfigure a mobile device. In such a case, download server 112 downloads software to carrier network 1xx, which sends the software to a mobile device, such as mobile device 102. Therefore, even if mobile device 102 is not initially-programmed to engage in the non-real time communication described herein, it can be after being deployed. More specifically, in one embodiment, each carrier network includes a specific MIME number for a particular application run by the mobile device. The MIME number allows a user browsing the World Wide Web on the cell phone to cause an application to be downloaded to the cell phone for use.

Exemplary Flow Processing

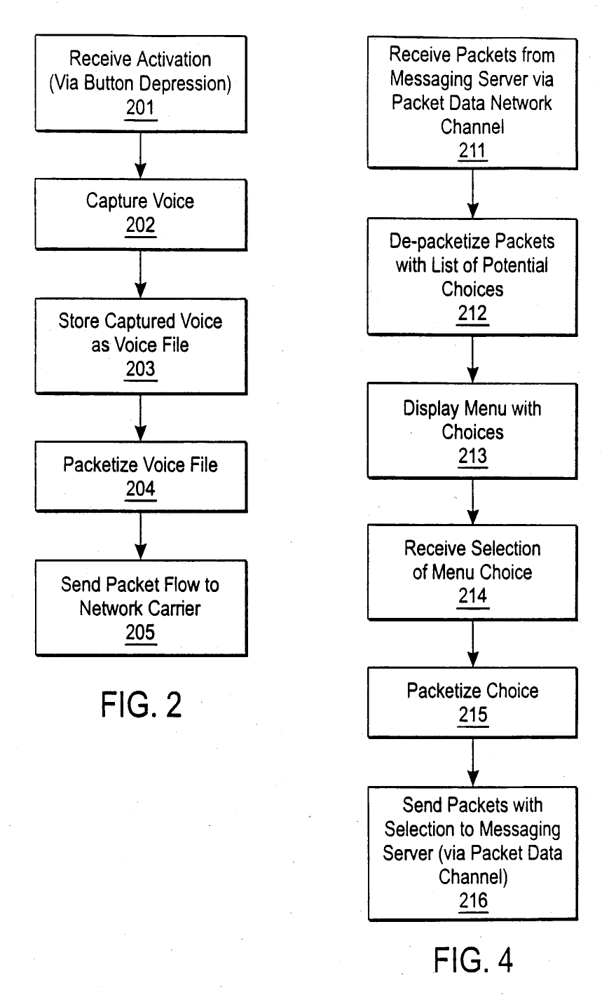

FIG. 2 is a flow diagram of one embodiment of a process performed by a mobile device in a network environment. The process is performed by processing logic which may comprise hardware (e.g., circuitry, dedicated logic, etc.), software (such as run on a general purpose computer system or a dedicated machine), or a combination of both.

Referring to FIG. 2, processing logic in a mobile device receives an activation indication (processing block 201). In one embodiment, such an activation may be received in response to the pressing of a button on the mobile device. The button may comprise a key on a keypad. In response to receiving the activation, the processing logic captures utterances (voice) (processing block 202 ) and stores the captured utterances in a file as a voice message (processing block 203). Subsequently, processing logic in a mobile device packetizes the voice file (processing block 204) and sends the packet flow to the network carrier (processing block 205).

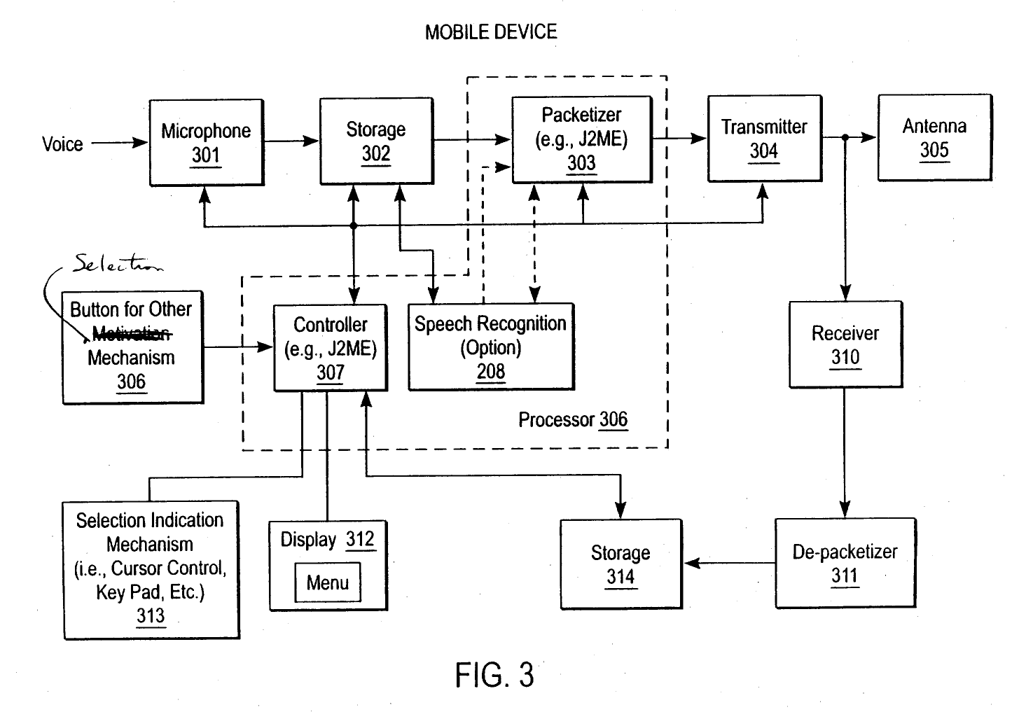

FIG. 3 is one embodiment of a mobile device, such as mobile device 101. Referring to FIG. 3, the user depresses a button or key, performs a stylus selection, or uses some other activation mechanism 309 that signals to controller 307 to operate in a non-real time mode. In response to depression of the button or other activation, microphone 301 records utterances or other audio information and stores the recorded utterances in storage 302.

The recorded utterances in storage 302 are packetized by packetizer 303 under control of controller 307 and transmitted wirelessly using transmitter 304 and antennae 305 to the carrier network using a packet data network channel (such as shown in FIG. 1). Packetizer 303 may be part of a channel modem on the mobile device that is coupled to transmitter 304. In one embodiment, although not shown, a codec and digital signal processor (DSP) may be included, where the DSP performs LPC coding on the recorded stream of utterances (prior to packetization) in a manner well-known in the art. In an alternative embodiment, the data stream may be processed by a codec and then the digital signal processing may be performed along with the packetization by a process running on processor 306.

In one embodiment, the recorded utterances stored in storage 302 undergo speech recognition using speech recognition 303. The recognized work are stored back in storage 302 or provided directly to packetizer 303.

In one embodiment, controller 307 and packetizer 303 are part of the processor 306. More specifically, processor 306 runs software that can set up and launch calls. This software packetizes voice input and causes the packets to be sent on to a data packet channel. Thus, in one embodiment, this software may include the functions performed by controller 307 and packetizer 303. In one embodiment, processor 306 executes a Java 2 Mobile Execution (J2ME) program such that the mobile device functions as a thin client. In one embodiment, the J2ME program (or another program executed by processor 306) includes a speech recognition routine to perform the speech recognition associated with speech recognition 303.

At times, such as when the messaging server is providing menu options to the user, a mobile device, mobile device utilizes a received path that includes receiver 310 that receives a service of packets from the messaging server that are depacketized using depacketizer 311 and stored in storage 314. Control 307 accesses the packets in storage 314 and displays them on display 312 as a menu selectable by the user. The user may use selection indication mechanism 313 to make a selection of one of the menu options. In one embodiment, the selection indication mechanism 313 may comprise a cursor control device, a keypad device, stylus, or other well known input device for selecting menu options on a display screen. The result of the selection sent by controller 307 to packetizer 303 and transmitted back out on packet data network channel to the messaging server.

Although not shown, the coupling of antennae to 305 to transmitter 304 and receiver 310 is usually through a switch or duplexer.

FIG. 4 is a flow diagram of one embodiment of a process performed by a mobile device to process menu items from a messaging server. The process is performed by processing logic which may comprise hardware (e.g., circuitry, dedicated logic, etc.), software (such as run on a general purpose computer system or a dedicated machine) or a combination of both.

Referring to FIG. 4, processing logic in a mobile device receives packets from the messaging server via the packet data network channel (processing block 211). In an alternative embodiment, the information from the messaging server is sent through the network carrier to the mobile device via a messaging or packet channel.

In response to receiving packets on the packet data network channel, processing logic in the mobile device de-packetizes the packets (processing block 212) and displays the menu with choices based on the information in the packets (processing block 213).

Subsequently, in response to a user selection, the processing logic in the mobile device receives the selection of a menu item (processing block 214), packetizes the selection (processing block 215), and sends the packets that include the selection to the messaging server via the packet data network channel and the carrier network (processing block 216).

If the menu is sent on the messaging channel, the user is able to respond by sending a responding message on the message channel in a well-known manner. Assuming the user selects one of the available menu options, the messaging server is able to comprehend the selection based on the fact that the messaging server sent the menu.

Voice Message Routing

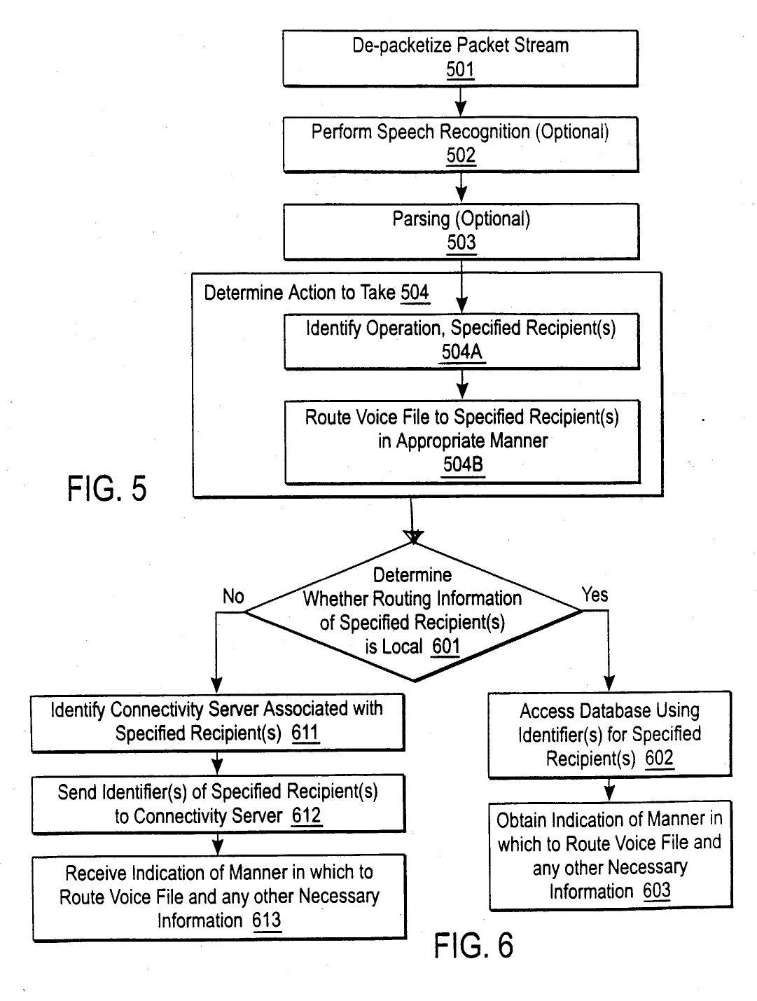

FIG. 5 is a flow diagram of one embodiment of a process to route a voice message. The process is performed by processing logic which may comprise hardware (e.g., circuitry, dedicated logic, etc.), software (such as run on a general purpose computer-system or a dedicated machine), or a combination of both. The process may be performed by messaging server 105 of FIG. 1, which runs software.

Referring to FIG. 5, processing logic in the messaging server depacketizes the packet stream containing a voice file received from mobile device, such as mobile device 101. The depacketizing may be performed by processor, general purpose or dedicated, running a depacketization module (routine). Alternatively, a depacketizer unit may be coupled to messaging server 105.

Processing logic in the messaging server then performs speech recognition (processing block 502). This may be optional in situations where the voice message received from the mobile device has already undergone speech recognition. The speech recognition may be performed by a speech recognition unit, speech recognition processor running a speech recognition module, or a general purpose processor running a speech recognition module.

Using the speech recognized information, processing logic in the messaging server may optionally perform parsing to identify key words or phrases in the voice message (processing block 503). Such parsing may be useful in identifying commands or specified recipients associated with the call so that a proper routing of information is performed by the messaging server. The parsing may be performed by a processor, general purpose or dedicated, running a parser module. Alternatively, a parser may be coupled to or associated with the messaging server.

With the speech recognized voice message, processing logic in the messaging server determines an action to take (processing block 504). In one embodiment, the processing logic determines an action to take by identifying the operation and the specified recipients (processing block 504) and routing the voice message to the specified recipients in the appropriate manner (processing block 504B). The routing may be performed by a processor, general purpose or otherwise, running a communication routing module, in conjunction with communications functionality (e.g., network information cards, transmitters, receivers etc.) capable of performing all the necessary communications. Alternatively, the routing may be performed by a communication or routing unit.

FIG. 6 is a flow diagram of one embodiment of the process performed by the messaging server to identify an operation associated with a voice message and one or more specified recipients. The process is performed by processing logic which may comprise hardware (e.g., circuitry, dedicated logic, etc.), software (such as run on a general purpose computer system or a dedicated machine), or a combination of both. In one embodiment, the process is performed by messaging server 105 of FIG. 1 running software.

Referring to FIG. 6, the processing logic in the messaging server initially determines whether routing information of the specified recipient(s) is stored locally (processing block 601). If the routing information of the specified recipient(s) is stored locally, processing logic in the messaging server accesses the database using identifiers for the specified individual(s) (processing block 602) and obtains an indication of the manner in which to route the voice message and any necessary information to the specified recipient(s) (processing block 603).

If the routing information of the specified recipient(s) is not stored locally, processing logic identifies a server (e.g., a connectivity server, a corporate server, etc.) associated with the specified recipient(s) (processing block 611), sends the identifier for the specified person to the identified server (processing block 612), and subsequently receives an indication of the manner in which to route the voice message to the specified recipient(s) and any necessary information to do so (processing block 613).

Switching Between Channels on the Mobile Device

In one embodiment, when using the mobile device for a circuit switch call, the user may press a button or use another selection mechanism to activate the packet data network channel. In such a case, the circuit switched call is put on hold by the mobile device continuing to process received packets/frames from the circuit switched network while sending idle speech data patterns into the network from the mobile device transmitter. Meanwhile, the speaker and microphone will be utilized by the packet channel process. In one embodiment, the speech decoder/encoder that is coupled between a speaker and a microphone on the mobile device and the mobile device's antenna is left running while its connections between the speaker and microphone are disconnected or disabled. In an alternative embodiment, a signal is sent to the cellular network provider who places the call into the hold state until further notified. When the user is finished with the packet data network channel, then the user presses the button or activates the selection mechanism again and the user is returned to the circuit switched call. This allows for the interruption of a circuit switched call to provide information to the messaging server. Interrupting a call to utilize the packet data channel may be useful, for example, to allow the user to place a caller on hold to make a meeting time notification within his personal information manager (PIM) through the messaging server to the connectivity server to the exchange server and the PIM.

These communications have a number of characteristics that will be described in more detail below. These characteristics may include, but not limited to, one or more following embodiments:

1) the communications are non-real time;

2) permit voice and data to the phone;

3) support group/chat room interactions;

4) may interact with PIM software based (as opposed to typing in the information), which permits a) launching of reminders or notifications from the PIM, b) the scheduling of calendar events (with conflict notification), and c) the ability to access the PIM address book for use in the routing of messages; and

5) an instant messaging interface to allow for speech based interaction. This utilizes text to speech and speech to text conversion software.

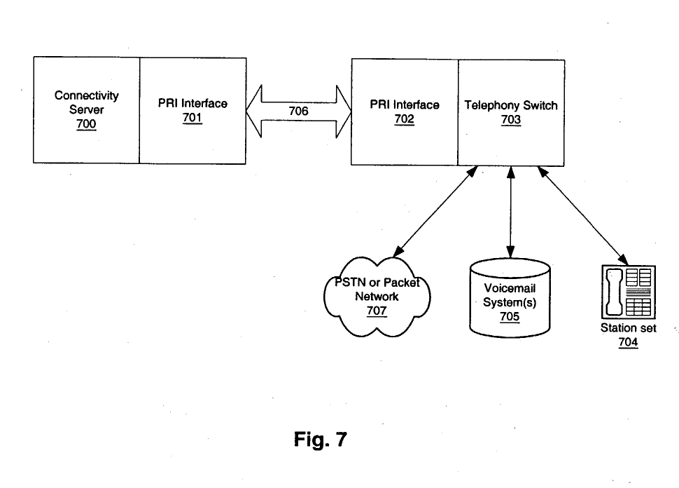

FIG. 7 shows the architecture of one embodiment of a communication system that may be used for the storage and retrieval of voice messages stored within voice mail systems. Referring to FIG. 7, in one embodiment, connectivity server 700 can be the connectivity server 110 in FIG. 1. Connectivity server 700 may be a physically distributed process. In other words, the processes described herein may be performed on a single server or on multiple servers (which are logically the same.) Connectivity server 700 includes an interface is added to the server hardware and software to provide for the provisioning of a Primary Rate Interface (PRI) 701.

Telephone switch 703 can be any type of circuit or packet switched voice switching system. Examples of telephone switches include PBX equipment, Centrex switches, Central office switches, Voice over Packet (VoP), Voice over IP (VOIP) voice switching systems. Telephone switch 703 provides voice connectivity between the PSTN or the packet network and station set telephones provided for the user. In one embodiment, telephone switch 703 allows the user to access the PSTN or VoP networks. In one embodiment, telephone switch 703 also allows for the storage and retrieval of voice messages within an adjunct voice mail system 705. Voice mail system 705 may be coupled to or part of a telephone switch. Voice mail systems are normally connected to a telephone switch via proprietary hardware and software interfaces and do not provide for the direct manipulation of their contents from within program control. For example, an offered PSTN call to station set 704 results in the activation of voice mail system 705 under certain conditions set within telephone switch 703. One such condition is the station set busy state of station set 704. As a result of station set 704 being busy, the offered call is routed to the voice mail system for the purpose of storing a voice message. Such a message is later retrievable by the station set owner via an access code. This application describes a store and retrieve communication system for voice messages intended for station set 704. Station set 704 may be one of the mobile devices described above.

PRI interface 702 provides for the provisioning of a Primary Rate Interface within telephone switch 703. Cable 706 is a PRI cable that crosses over the interface points of the PRI, i.e. exchanging the transmission and the reception interface. This allows PRI interface 701 to communicate directly with PRI interface 702 via the PRI. In one embodiment, the CCITT Q931 standard call setup and teardown over PRI is used.

In one embodiment, connectivity server 700 has a speech recognizer to perform speech recognition and a speech synthesizer to perform speech synthesis. These may be implemented with automatic speech recognition (ASR) and speech synthesis (e.g., Text-to-Speech (TTS)) software and/or hardware.

In one embodiment, connectivity server 700 determines that the contents of the voice mail box for station set 704 (i.e., for a subscriber) should be examined. This determination may be performed in response to one of a number-of potential indicators. For example, connectivity server 700 may poll the voice mail box at regular or scheduled intervals. Another method is for the message waiting light (or other such indicator), provided on many PBX systems, to be reflected onto one of the ports provided by the PBX at the PRI interface point. This can occur through the use of ghost ports, where everything that happens on port 704 is reflected to another port. Telephony control (e.g., a program in connectivity server 700, hardware in connectivity server 700, or both) may instruct telephone switch 703 to turn on the message waiting light for station set 704. This telephony control may generate a message light indication (e.g., a stutter tone, a 90 volt light turned on, a digital message through a digital protocol between telephone switch 703 and station set 704 that tells station set 704 to turn on the message waiting light). Alternatively, connectivity server 700 may detect the presence of stutter tone, as provided with many Centrex systems.

In one embodiment, connectivity server 705, through connectivity server telephony control, retrieves voice messages that are stored on voice mail (VM) system 705 by launching (offering) a call through the PRI interface into telephone switch 703. The connectivity server telephony control dials the voice mail server of VM system 705 directly, bypassing station set 704. This prevents station set 704 from audibly ringing when the connectivity server telephony control 's call is offered. The connectivity server telephony control determines the call progress of the offered call in terms of setting a connection (e.g., offered call, waiting; dialing, ringing, answering, etc.) by utilizing speech recognition software and/or hardware provisioned within connectivity server 700. Alternately, digital signal processing (DSP) algorithms can be utilized to detect tone components generated by VM system 705 and telephone switch 703. Upon determining the cessation of ring tone, the connectivity server telephony control captures the speech utterance of VM system 705 and processes the speech through an ASR on connectivity server 700. In an exemplary call flow, the connectivity server telephony control then provides VM system 705 with the user's mail box/station set extension and PIN number which either the user and/or administrative IT manager had previously provisioned within the user's profile settings on connectivity server 700. The connectivity server telephony control may use DTMF tones generated within connectivity server 700 or alternatively speech generated from the TTS hardware and/or software within connectivity server 700 to provide the user's mail box/station set extension and PIN number when prompted by the voice mail system. In an exemplary call flow, the connectivity server telephony control then processes the speech from VM system 705 with the ASR hardware and/or software of connectivity server 700 to determine the number of new messages and the number of old messages. The connectivity server telephony control then causes VM system 705 to play the stored voice mails in audio form by generating the DTMF tones or audio controls necessary to cause VM system 705 to begin this operation. An example call flow is as follows:

| Connectivity Server/Telephony Control | Voice Mail System |
|---|---|
| 1) Offers a call to station 123 | |
| | 2) Answers the call after a call |
| | forward on busy by the |
| | Telephony Switch to the Voice |
| | Mail System |
| | 3) Plays Audio Prompt “Hi, the |
| | person you reached is Bob . . . |
| | please leave a message at the |
| | beep” |
| 4) Sends the pre-configured user access | |
| sequence, by generating the DTMF | |
| tones indicative of the required | |
| sequence | |
| | 5) Validates the user access |
| | sequence |
| | 6) Plays Audio information, |
| | “You have 5 new voicemails |
| | and 6 old voicemails . . . |
| | Press 1 to play your new |
| | messages” |
| 7) Uses speech recognition to determine | |
| the numbers “5” and “6” in the previous | |
| audio information | |
| 8) Generates the DTMF tone for “1” | |
| | 9) Receives the DTMF tone for |
| | “1” and plays audio |
| | information about the first |
| | message “Message received at |
| | 10:42 am” then begins to play |
| | the content of the message |
| 10) Uses speech recognition to | |
| determine the audio information | |
| “10:42 am” and then begins to record | |
| the message | |
| | 11) Finishes playing the first |
| | message and prompts the user |
| | for directions on what to do with |
| | the message, “Press 1 to |
| | delete, 2 to save” |
| 12) Generates the appropriate DTMF | |
| tone to delete or save the message | |
| dependent on the previously configured | |
| information in the user's profile on the | |
| connectivity server | |

This sequence continues until all the messages have been played.

In one embodiment, the connectivity server telephony control records the voice messages into storage areas within connectivity server 700 for later manipulation. In an alternate embodiment, the connectivity server telephony control plays the message to determine key parameters of the message, such as, for example, length, originator, and/or urgency level and leaves the message on VM system 705 essentially using VM system 705 as a voice storage facility. The originator and/or urgency level may be determined by using ASR on portions of a voice message to identify the individual(s) that left the message and determine the urgency level.

The above scenario describes one of many call progress scripts that can occur. Other scenarios are determined by the voice mail system's proprietary methods and vary greatly from VM system to VM system. The connectivity server telephony control determines its call progress from a set of scripts that are provided within connectivity server 700. The selection of which script to utilize is determined by the user profile as set within connectivity server 700. Note that the connectivity server telephony control is not restricted to interacting with a single voice mail system on behalf of the user. The connectivity server telephony control can interact with multiple VM systems that are external to the telephony switch environment by placing a call through a telephony switch to an external VM system via the PSTN or packet networks. Thus, the JTS can aggregate multiple VM systems into a single presentation to the user of the contents of multiple VM systems.

The parameters of a voice message can be its length, its urgency level, its originator, and its time of arrival into the VM system. Determining the VM's length is accomplished, in most VM systems, by playing the message and measuring the time. Note that the entire message need not be played linearly in that in some VM systems the connectivity server telephony control can repeatedly skip ahead by some period of time in the message, e.g. 10 seconds at a DTMF command and calculate the message length to an accuracy of plus or minus 10 seconds. The urgency level can be determined by performing automatic speech recognition (ASR) the VM system's spoken urgency level for each message. The originator can be determined by the connectivity server telephony control capturing and performing ASR on the calling number ID information captured by the VM system and spoken by the VM system on playback of the message. The originator can also be determined by ASR of the voice mail contents. In this case, in one embodiment, the user's voice mail message prompt asks the user to begin the message by stating his name. On playback, the connectivity server telephony control performs ASR on this information and attempts to correlate the name to a name contained within the user's address book that has be previously provisioned into connectivity server 700 or within access of connectivity server 700 in locations such as the address book of the Personal Information Manager (PIM) of the user. An example of this would be the Microsoft Outlook address book accessible by connectivity server 700 via an exchange server (e.g., Microsoft exchange) server on the corporate internal network. The time of message arrival into the VM system is determined by the connectivity server telephony control via performing ASR on the spoken time by the VM system when the VM system states the time.

In one embodiment, the connectivity server telephony control can control VM system 705 via DTMF tones causing it to play the message at faster speeds, thus reducing the amount of time consumed on the PRI for interfacing with a single VM box, back up, skip ahead, etc.

Once the connectivity server telephony control determines that the user has voice mail messages and has determined the key parameters of those messages, connectivity server 700 provides this information to the user's mobile device by sending a text message over one of the packet channels available to the mobile device. The mobile device, which, in one embodiment is running a software program (e.g. a J2ME JAVA program), presents a list of messages or a set of icons representing the messages to the user. The user can then select one or multiple list items from the mobile device's display. This selection along with the mobile user device ID and the phone number for presentation is communicated back to connectivity server 700 via a wireless packet channel (e.g., packet data network channel, messaging channel) or wired packet channel (element 131 of FIG. 1) and the internet as described above. The user device ID is a number pre-assigned to the user and device so if a user has multiple devices each has a unique number that is known to the communication system as being uniquely that particular user's device. In one embodiment, upon receiving of the selection information, connectivity server 700 originates a call via the PRI interface to the phone number for presentation and causes the selected voice mail message to be played to the user over the audio path created by the Circuit Switched call or the packet switched (e.g., VoP) call. In one embodiment, the user has VM like control via DTMF tones of the playback of the voice mail. That is, for example, the user can skip forward or back, speed up or slow down the play, delete the message, and/or save the message. These operations may be selected by the user by normal button pushes on the phone causing the generation of DTMF tones. The connectivity server telephony control implements the user's selections.

Note that for systems in which the message is stored within connectivity server 700, the connectivity server telephony control has direct control of the message. For systems that utilize the storage of the VM system, the connectivity server telephony control places a second call through the PRI to VM system 705 and bridges the audio through to the remote user including translating the control information for the playback of the message.

In an alternative environment, the connectivity server telephony control provides the audio via a packet channel directly to the mobile device either by offering a VoP call or by directly utilizing the digital packet data network channel to carry the packetized voice of the message to the user. Using non-wireline, VoP techniques can improve the performance of the system by accounting for the environment of the wireless packet channel with its fading handoff, roaming and dropout conditions.

Once the VM message has been played to the user, the user can select the next message via DTMF control or text menu control over the digital packet data network channel or the user can terminate the audio portion of the call by hanging up.

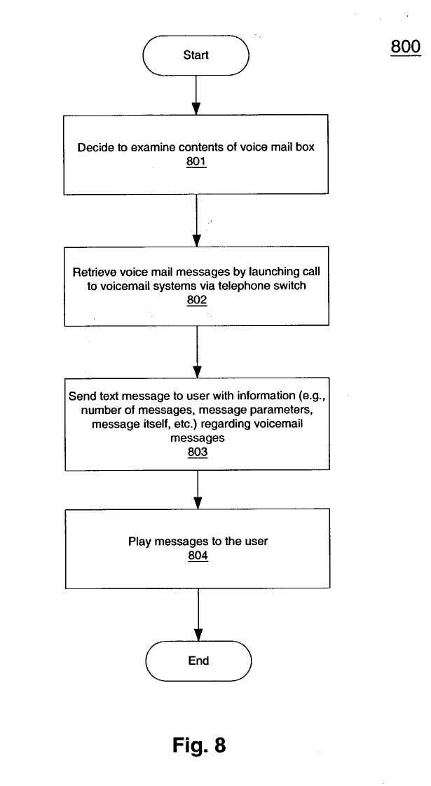

FIG. 8 is a flow diagram of one embodiment of the voice mail control process described above.

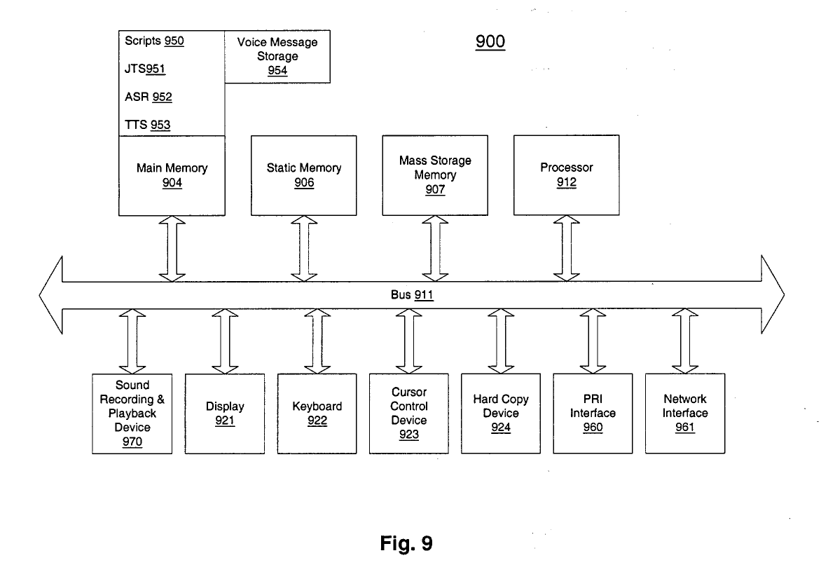

FIG. 9 is a block diagram of a one embodiment of a connectivity server. Referring to FIG. 9, the connectivity server may comprise a computer system 900 in which the features of the present invention may be implemented. Computer system 900 comprises a communication mechanism or bus 911 for communicating information, and a processor 912 coupled with bus 911 for processing information. Processor 912 includes a microprocessor, but is not limited to a microprocessor, such as Pentium ™, PowerPC™, etc.

System 900 further comprises a random access memory (RAM), or other dynamic storage device 904 (referred to as main memory) coupled to bus 911 for storing information and instructions to be executed by processor 912. Main memory 904 also may be used for storing temporary variables or other intermediate information during execution of instructions by processor 912. Main memory 904 may store the scripts 950 associated with each of the different voice mail systems that are to be communicated with using the connectivity server, as well as the connectivity server telephony control 951 with modules to perform the specific functions (e.g., launching a call, receiving a call, playing a message, recording audio, dialing a number, deleting a message, speech recognition, text-to-speech conversion, etc.). Also stored in memory 904 is ASR software 952, TTS software 953, voice mail messages 954 retrieved from voice mail systems, and communication software for running the PRI interface 960 to provision a PRI, the network interface 961 to interface with one or more networks (e.g., Internet, WAN, LAN, etc.) and any other input/output devices described herein.

Note that in an alternative embodiment, the software and the functions performed in response to execution thereof may be performed instead using hardware in computer system 900 or a combination of hardware and software.

Furthermore, a sound recording and playback device 970, such as a speaker and microphone are coupled to bus 911 for audio interfacing with computer system 900.

Computer system 900 also comprises a read only memory (ROM) and/or other static storage device 906 coupled to bus 911 for storing static information and instructions for processor 912, and a data storage device 907, such as a magnetic disk or optical disk and its corresponding disk drive. Data storage device 907 is coupled to bus 911 for storing information and instructions.

Computer system 900 may further be coupled to a display device 921, such as a cathode ray tube (CRT) or liquid crystal display (LCD), coupled to bus 911 for displaying information to a computer user. An alphanumeric input device 922, including alphanumeric and other keys, may also be coupled to bus 911 for communicating information and command selections to processor 912. An additional user input device is cursor control 923, such as a mouse, trackball, trackpad, stylus, or cursor direction keys, coupled to bus 911 for communicating direction information and command selections to processor 912, and for controlling cursor movement on display 921.

Another device which may be coupled to bus 911 is hard copy device 925, which may be used for printing instructions, data, or other information on a medium such as paper, film, or similar types of media. Note that any or all of the components of system 900 and associated hardware may be used in the present invention. However, it can be appreciated that other configurations of the computer system may exist.

An Exemplary Extension

The above described system of FIG. 7 can be extended to include the ability for the calling party to leave a subject field within the VM message. The connectivity server performs automatic speech recognition (ASR) on the subject field and includes the subject field as text in a list of available messages presented to the user. The system can also be extended to include full speech to text conversion of the VM message for presentation to the user over the digital packet channel.

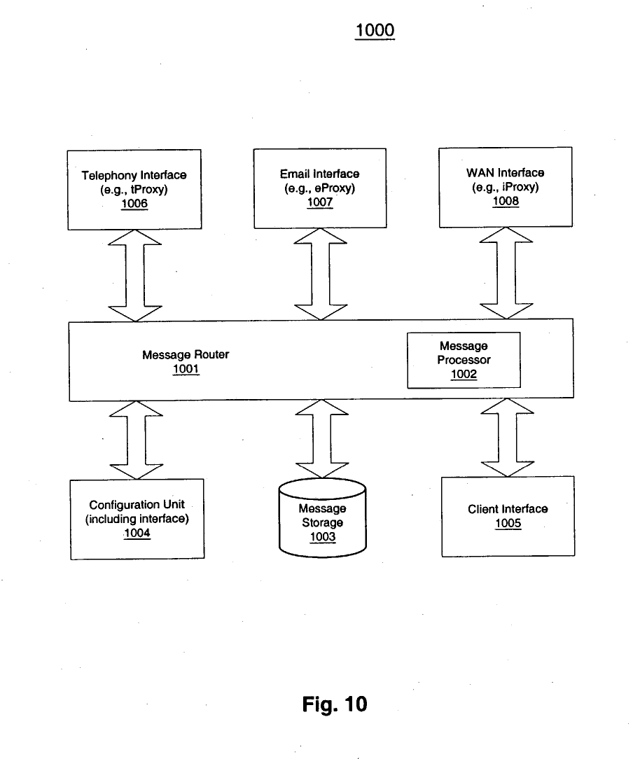

FIG. 10 is a block diagram of an embodiment of a connectivity server that may be used for processing voice messages. The exemplary connectivity server 1000 may be used as connectivity server 110 of FIG. 1 or connectivity server 700 of FIG. 7. In one embodiment, exemplary server 1000 includes a message router 1001 which may include a message processor 1002, a configuration unit 1005, a message storage 1003, client interface 1005, a telephony interface (also referred to as tProxy) 1006, an email interface (also referred to as eProxy) 1007, and a WAN (e.g., Internet) interface (also referred to as iProxy) 1008. Note that message storage 1003 may be implemented within connectivity server 1000. However, message storage 1003 may not be a part of connectivity server 1000 and it may locate remotely over a network. Furthermore, message storage 1003 may be a third party storage facility over a network, such as a storage area network over the Internet. Other components apparent to one with ordinary skill in the art may be included.

According to one embodiment, when message router 1001 receives a voice message from a client via client interface 1005, message router 1001 may store the received voice message in message storage 1003. Message router 1001 may also examine a profile of the client which may be stored in message storage 1003 or other storage drives at the same or at another location. The profile of the client may include information or policies regarding the client's preferences, etc. The profile of the client may be configured by configuration unit 1004 via an interface, such as a graphical user interface (GUI). If message router 1001 determines that the address (e.g.,m a person's name, a group name such as an enterprise group, etc.) and the subject matter need to be recognized, message router 1001 may forward the voice message to telephony interface 1006 to have the address and subject matter recognized. Telephony interface 1006 may segment the voice message to extract the address and subject information and transcribe the information into a text format. In one embodiment, the address and subject information may be extracted based on the keywords used. Telephony interface 1006 may invoke an automatic speech recognition (ASR) system to perform the transcription. The text transcribed may be forwarded back to message router 1001 and message router 1001 stores the text in message storage 1003.

For example, a client may dictate, via client interface 1005, a voice message of “to Mary, subject tomorrow's meeting (followed by the rest of the message)”. In response, message router 1001 (under direction of message processor 1002 ) stores the message in message storage. 1003. If message processor 1002 determines that the address (e.g., Mary) and the subject need to be recognized, message processor 1002 may cause contents of the stored audio message to be forwarded to telephony interface 1006. Telephony interface 1006 takes the voice message and breaks it into segments using keywords, such as “subject”. The address may be recognized via an address book which may be stored in storage 1003 or other storage drives. Telephony interface 1006 then generates a text message base on the segmented message. Telephony interface 1006 may invoke an ASR system to transcribe the address and subject into the text message and thereafter, telephony interface 1006 forwards the text message back to message router 1001 and message router 1001 may store the text message in message storage 1003 in a location associated with the voice message.

According to one embodiment, message router 1001 may transmit the text message representing the subject matter of the voice message (instead of the entire voice message) to the designated recipient (e.g., Mary) over a data packet channel using one of the aforementioned techniques. The text message may be included in a menu of selectable options that allow the recipient to select which voice message to be retrieved. The text message may include a predetermined phone number offering to call the recipient to play the selected voice messages.

Alternatively, the respective recipient may prefer the voicemails to be played through a call to a specific callback number which may be specified in the recipient's profile through a user interface of the configuration unit. Based on the recipient's preferences, the system may directly call the recipient using the callback number to play the voicemails. When the recipient picks up the call, the system may prompt the recipient to select specific voicemails to play or delete a selected voicemails from the system, etc.

It will be appreciated that the recipient's profile may include multiple options that a voicemails can be delivered. For example, according to one embodiment, a recipient may provide multiple callback numbers for a cellular phone, an office phone, and a home phone, etc. The recipient may be able to specify which phone number to be called when certain conditions of the voicemails are met. For example, a recipient may specify any high priority (e.g., urgent) voicemails or voicemails from a specific person should be call to his/her cellular phone. Alternatively, the recipient may provide one or more email addresses to receive the voicemails in a text format. This is particularly useful when the voicemails are long and have low priority. In one embodiment, the system may scan each of the options to find one that is suitable to reach the recipient under the circumstances. Other configurations may be utilized.

In response to a selection of one or more voice messages from the recipient, message router 1001 may forward the selected voice message to telephony interface 1006 to call the predetermined number and to play the selected voice messages in the same manner as described above. The predetermined number may be defined initially when the client registered with the system (via configuration unit 1004). In one embodiment, this alternative callback number may be specified by editing the predetermined number in a reply email to be the alternative callback number. In an alternative embodiment, the recipient may specify an alternative callback number within the selection. In another embodiment, the recipient may respond to specify the voicemails(s) is to undergo speech-to-text (STT) conversion and be transmitted in a text format, such as, for example, via an email, which is described in details further below.

In a further embodiment, the recipient may indicate that he/she wishes the voice message played over a wide area network (WAN), such as Internet. In response, message router 1001 may forwards the voice message in a digital format (e.g., multimedia audio files) to WAN interface 1008 to allow the recipient to download (e.g., via a hypertext link) the audio files over the WAN and to play the audio files using a digital audio player, such as, for example, an MP3 player, or alternatively, using a multimedia application of a computer, such as Windows media player, etc. Furthermore, message router 1001 may stream the voice messages to the client over the Internet using voice over IP (VoIP) techniques.

According to one embodiment, if the recipient prefers the voicemails to be delivered in a text format, message router 1001 may forward a voicemails to telephony interface 1006 and instruct telephony interface 1006 to transcribe all or substantially all the audio message of the voicemails into one or more text messages. Thereafter, message router 1001 may transmit a text message corresponding to each converted voicemails message to one or more recipients via email interface 1007 or WAN interface 1008. In one embodiment, telephony interface 1006 invokes an automatic speech recognition (ASR) system to transcribe the voicemails into one or more text messages. Message router 1001 may determine whether the respective client (e.g., the recipient) wants to receive the voicemails in an audio format or a text format and takes actions accordingly. In one embodiment, such a decision is determined based on the respective client's profile. The client's profile may include client's preferences. The client's preferences may be predefined by the client via a GUI of configuration unit 1004. Alternatively, the recipient client may specify that he/she wishes to receive voicemails in either a text format or an audio format when the client responds to the notification text message via the data packet channel. Furthermore, message router 1001 may detect that the recipient's device is only able to receive audio messages or vice versa and message router 1001 transmits voicemails accordingly (e.g., either in a text format or. an audio format).

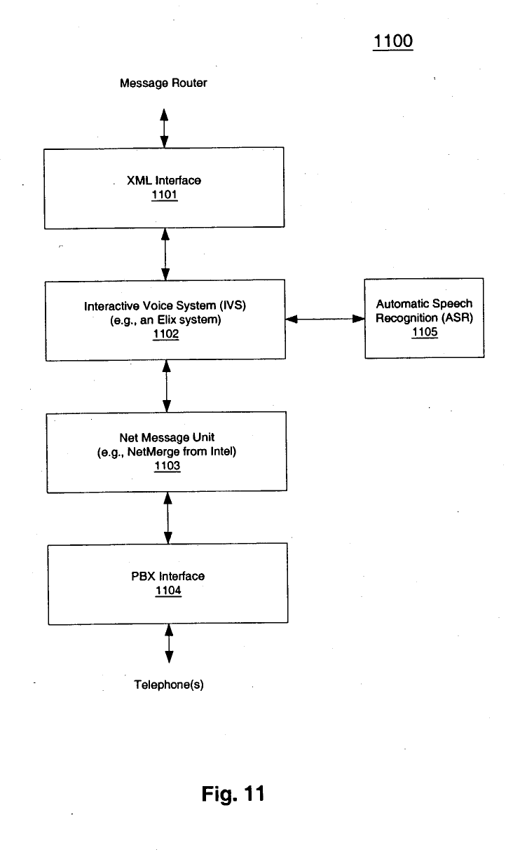

FIG. 11 is a block diagram of an embodiment of a telephony interface which may be used as telephony interface 1006 of FIG. 10. In one embodiment, exemplary telephony interface or system 1100 includes an XML (extended markup language) interface 1101 to receive voice message from message router 1001 and to transmit the transcribed text messages back to the message router 1001. In addition, telephony interface 1100 may also include an interactive voice system (IVS) 1102, such as an Elix IVS system from Elix. IVS 1102 may also include an automatic speech recognition (ASR) system 1105 to transcribe a voice message into a: text message. Furthermore, telephony interface 1100 may also include a net message unit 1103, such as NetMerge from Intel Corporation which provides an interface from IVS 1102 to PBX interface 1104. Telephony interface 1100 may include a PBX interface 1104 to interface with one or more station sets, such as station set 704 of FIG. 7 over a telephony network. Other components apparent to one with ordinary skill in the art may be included.

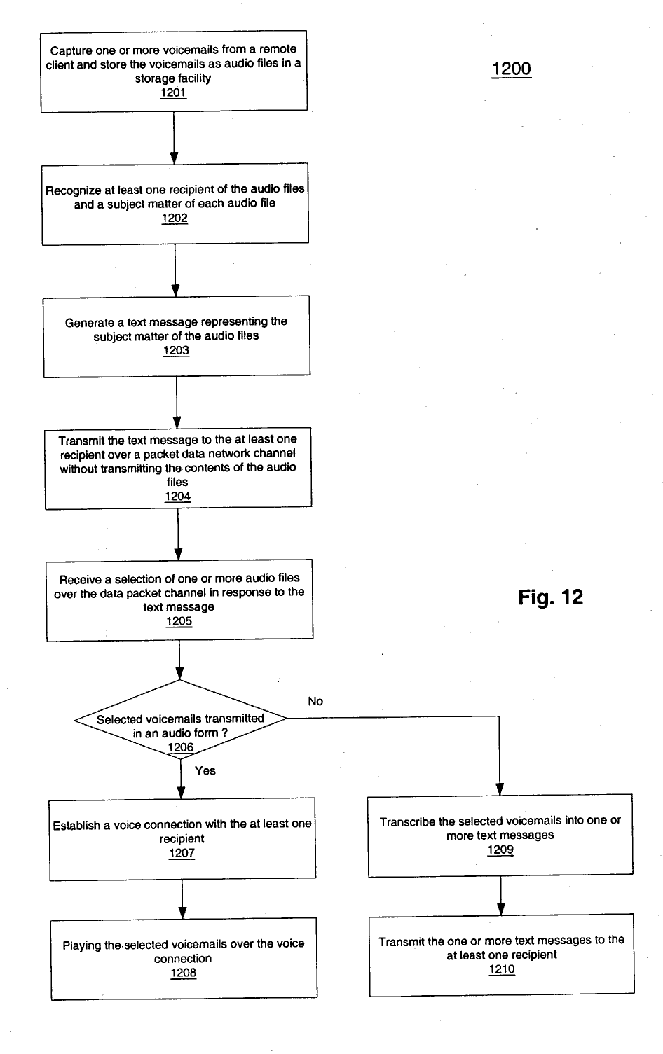

FIG. 12 is a flow diagram of an embodiment of a process for processing voice messages. The process is performed by processing logic which may comprise hardware (e.g., circuitry, dedicated logic, etc.), software (such as run on a general purpose computer system or a dedicated machine), or a combination of both. In one embodiment exemplary process 1200 may be performed by connectivity server 1000 of FIG. 10. Referring to FIG. 12, in one embodiment, exemplary process 1200 includes processing logic identifying at least one recipient of one or more audio files stored in a storage facility, recognizing a subject matter of the one or more audio files, generating a text message representing the subject matter of the one or more audio files, and transmitting the text message to the at least one identified recipient over a packet data network channel without transmitting the contents of the one or more audio files.

Referring to FIG. 12, at processing block 1201, processing logic captures one or more voicemails from a remote client and stores the voicemails as one or more audio files in a storage facility. The storage facility may be located locally within the server or via a local area network (LAN). Alternatively, the storage facility may be located remotely over a network, such as storage area network (SAN). At processing block 1202, processing logic recognizes at least one recipient of the audio files and the subject matter of the each audio file. In one embodiment, the recipient and subject matter may be identified based on one or more keywords within the audio files. The recipient and subject matter may be segmented and identified via an ASR system. The ASR system may be located locally. Alternatively, the ASR system may be located remotely via a secure link. For example, the ASR may be employed through a third party facility over a network, such as the Internet.

At processing block 1203, processing logic generates a text message based on the identified recipient and subject matter. The text message may be a short message representing the sender, the subject matter, and the duration of the audio message of the voicemails. In one embodiment, an ASR system may be invoked. At processing block 1205, processing logic transmits the text message to the at least one recipient over a data packet channel without transmitting the contents of the voicemails. In one embodiment, the text message is displayed at a display of the at least one recipient including a selectable menu where the respective recipient may select which voicemails to retrieve. In addition, the text message may include a predetermined phone number (e.g., a callback phone number) offering to call to play one or more voicemails upon a selection from the recipient. The predetermined phone number may be stored previously in a storage facility by the recipient via a GUI of a configuration scheme, such as configuration unit 1004 of FIG. 10. In response, the recipient may select one or more voicemails to retrieve.

In addition, the recipient may alter the callback number other than the default one. The new callback number may be included in the response of the recipient. Alternatively, the recipient may specify, through the response, that he/she wish to receive the voicemails in a text format. The recipient may provide a designated email address as a part of the response that the voicemails in a text form may be transmitted. Furthermore, the recipient may specifies, as a part of the response, to receive the voicemails via a wide area network (WAN), such as an Internet, where the voicemails may be stored in a digital audio format that suitable to be downloaded (e.g., via a hypertext link) and played using a digital audio player (e.g., an MP 3 player) or multimedia applications (e.g., Windows media player), etc.

Referring back to FIG. 12, at processing block 1205, processing logic receives a selection of one or more audio files over the data packet channel from the recipient in response to the text message. At processing block 1206, processing logic determines whether the selected voicemails need to be transmitted in an audio form or a text form using one of the aforementioned techniques. If the selected voicemails need to be played in an audio form, at processing block 1207, processing logic establishes a voice connection with the recipient by calling a predetermined number specified by the recipient and plays the selected voicemails over the voice connection. Alternatively, processing logic may stream the voicemails in a digital audio form to the recipient over the Internet using VoIP techniques.

If processing logic determines that the selected voicemails need to be transmitted in a text format, at processing block 1209, processing logic transcribe the selected voicemails into one or more text messages and transmits the transcribed one or more text messages to the recipient via, for example, an email. In one embodiment, an ASR may be used to transcribe the voicemails into one or more text messages.

An Alternative Exemplary Extension

In one embodiment, the system of FIG. 7 can be extended to allow the user to initiate the determination of the status of the preselected VM systems. The system can be extended to allow the status information to be placed within the user's e-mail system via, for example, Microsoft Exchange and Microsoft Outlook PIM program. The system can be extended to allow for selection of the message via the user's PIM causing the connectivity server and the JTS to offer a call to the destination phone and play back the message.

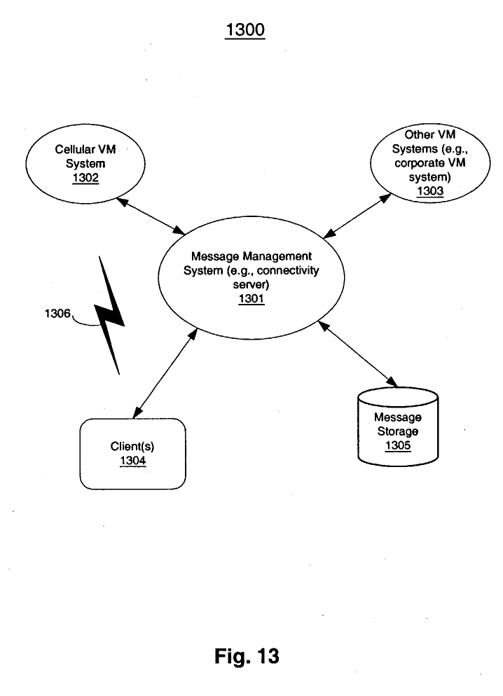

FIG. 13 is a block diagram of an embodiment of a system for controlling voice messages. In one embodiment, exemplary system 1300 includes a message management system 1301, such as connectivity server 1000 of FIG. 10, a cellular voicemails system 1302, one or more clients 1305, message storage 1305, and other voicemails systems 1303, such as corporate voicemails systems. Other components apparent to one with ordinary skill in the art may be included. In this embodiment, a client's voicemails may come from cellular voicemails system 1302 and other voicemails systems 1303 (e.g., a corporate voicemails system).

According to one embodiment, when cellular voicemails system 1302 receives a voicemails for client 1305, cellular voicemails system 1302 notifies client 1304 via a wireless media 1306, such as cellular communication network. In response, client 1304 communicates with message management system 1301 to retrieve the voicemails status. In one embodiment, client 1304 may send a signal via a data packet channel to system 1301. In response, system 1301 may send a text message to client 1304 over a data packet channel. The text message may include a selectable menu representing status of one or more voicemails systems. Client 1304 may select one or more voicemails systems to retrieve one or more voicemails. In response, system 1301 may retrieve the voicemails from cellular voicemails system 1302, extract the subject matter of the voicemails, and transmit the subject matter in a text form to client 1304 via the data packet channel using one of the aforementioned techniques. In addition, according to one embodiment, system 1301 may also retrieve any new voicemails of client 1304 from other voicemails systems, such as voicemails systems 1303. Voicemails systems 1303 may need to register with system 1301 previously. When client 1304 registers with system 1301, system 1301 may prompts client 1303 to enter the client's username and password in order to allow the client to log in configuring the client's profile and other attributes. In one embodiment, such processes require a secure connection and other authentication processes using, for example, SSL techniques. The registration may be handled by a configuration server (e.g., configuration unit 1004 of FIG. 10) by client 1304 or an administrator of a corporation.

According to another embodiment, a communication device of client 1304 may include a selectable mechanism, such as a button (e.g., a “check VM” button), when activated, the device sends a signal to system 1301 over a data packet channel to instruct system, 1301 to update the status of one or more voicemails systems (e.g., voicemails systems 1302 and 1303). The communication device may include a selectable menu to select one or more voicemails systems whose status may be updated. In response, system 1301 retrieves status of the selected voicemails systems and transmits the status to client 1304. The status retrieved from the selected voicemails systems may be performed transparently to the respective voicemails systems. In one embodiment, the respective voicemails system interprets that access to the voicemails system is performed by client 1304 itself.

In one embodiment, certain messages (e.g., from specific addressee and/or important messages) may be specified to have automatically converted into a text message and the text message may be transmitted (e.g., via an email) to client 1304 or one or more recipient.

According to another embodiment, system 1301 may periodically monitor status of voicemails systems 1302 and 1303 and store the status in a storage facility. The status may include a list of messages including unread and read messages. Alternatively, the status may include the priority of each message (e.g., “urgent”. System 1301 may update client 1304 actively if the client's communication device is turn on. Otherwise, client 1304 may retrieve the status (e.g., by activating the specific button) from system 1301.

Furthermore, according to another embodiment, when system 1301 detects that there is a status update from one of the voicemails systems 1302 and 1303, system 1301 may notify client 1304 (e.g., sends an email to client 1304 via an email interface, such as email interface 1007 of FIG. 10). The email sent to client 1304 may include subject matter of each voicemails with an identifier and a callback number offering to call to play the voicemails using one of the aforementioned techniques. In response, client 1304 replies the email to indicate which voicemails (via the respective identifier) to retrieve. In one embodiment, client 1304 may alter the callback number within the email. Thereafter, system 1301 may call the number specified by client 1304 and play the selected voicemails. The callback number specified in the initial email may be the default circuit switched voice number for the individual. In addition, according to one embodiment, the emails between system 1301 and client 1304 may be encrypted using an SSL (secure socket layer) technique.

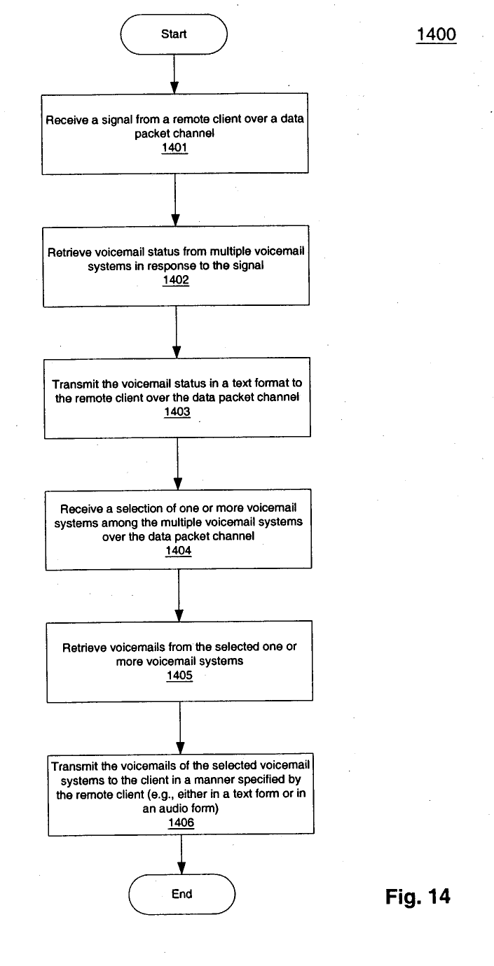

FIG. 14 is a flow diagram of an embodiment of a process for managing voice messages. The process is performed by processing logic which may comprise hardware (e.g., circuitry, dedicated logic, etc.), software (such as run on a general purpose computer system or a dedicated machine), or a combination of both. In one embodiment exemplary process 1400 may be performed by message management system 1301 of FIG. 13. In one embodiment, exemplary process 1400 includes receiving a signal from a remote client over a data packet channel, retrieving voicemails statuses from one or more voicemails systems in response to the signal, and transmitting the voicemails status in a text format to the remote client over the data packet channel.

Referring FIG. 14, at processing block 1401, processing logic receives a signal from a remote client over a data packet channel. -The signal may be transmitted by activating a button at the client's communication device. In response to the signal, at processing block 1402, processing logic retrieves voicemails status from one or more voicemails systems. The voicemails systems may include a cellular voicemails system and other voicemails systems, such as, for example, corporate voicemails systems. At processing block 1403, processing logic transmits the voicemails status in a text format to the remote client over the data packet channel. The voicemails status in the text format may include a selectable menu to select one or more voicemails systems to retrieve respective voicemails. At processing block 1405, a selection of one or more voicemails systems among the multiple voicemails systems is received over the data packet channel. In response to the selection, at processing block 1405, processing logic retrieves the voicemails from the selected voicemails systems and at processing block 1406, processing logic transmits the retrieved voicemails to the client in a manner specified by the client (e.g., either in a text format or in an audio format) using one of the aforementioned techniques.

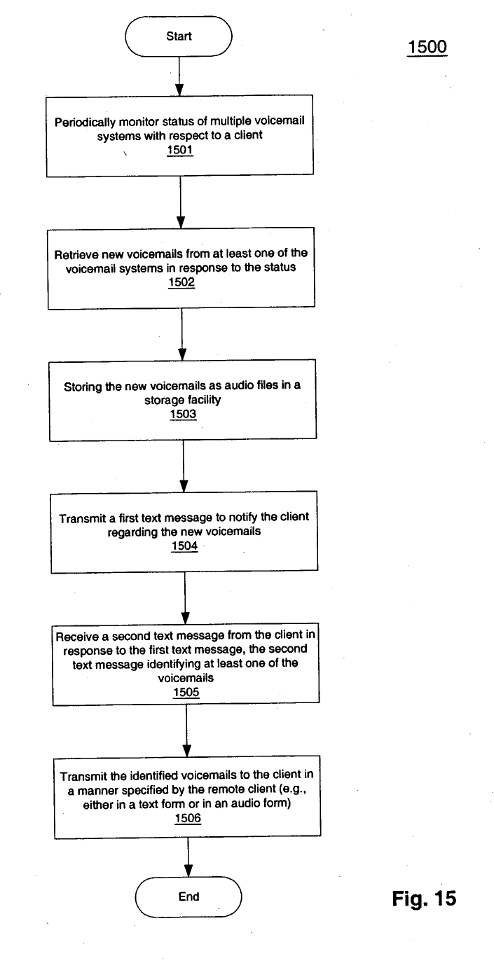

According to another embodiment, the status of multiple voicemails systems may be monitored constantly or periodically. FIG. 15 is a flow diagram of an embodiment of a process for managing voicemails. The process is performed by processing logic which may comprise hardware (e.g., circuitry, dedicated logic, etc.), software (such as run on a general purpose computer system or a dedicated machine), or a combination of both. In one embodiment exemplary process 1500 may be performed by message management system 1301 of FIG. 13. In one embodiment, exemplary process 1500 includes periodically monitoring status of a plurality of voicemails systems with respect to a client, retrieving new voicemails from at least one of the voicemails systems in response to the status, storing the new voicemails as audio files in a storage facility, and transmitting a first text message to notify the client regarding the new voicemails.

Referring to FIG. 15, at processing block 1501, processing logic periodically monitors status of multiple voicemails systems with respect to a client. The one or more voicemails systems may include a cellular voicemails system, such as cellular voicemails system 1302, and one or more other voicemails systems, such as corporate voicemails systems 1303. In response to the status, at processing block 1502, processing logic retrieves any new and old voicemails from at least one of the voicemails systems. At processing block 1503, processing logic stores the new voicemails as respective audio files in a storage facility, such as storage facility 1305 of FIG. 13.

At processing block 1505, processing logic transmits a text message to the client to notify the client that the client has at least one new voicemails. In one embodiment, the text message is transmitted to the client's mobile device (e.g., cellular phone, a wireless PDA, or a pager, etc.) via a data packet channel. Alternatively, the text message is transmitted via an email to the client's dedicated email address. In one embodiment, the text message may include a predetermined callback phone number offering a call to play the new voicemails. The callback phone number may be encrypted using an encryption mechanism, such as, for example, a public/private key pair from a commercial vendor (e.g., Pretty Good Privacy or PGP).

In response, the client may reply the text message and the replied text message is received by the processing logic at processing block 1505. The replied text message may identify at least one of the voicemails to retrieve. In one embodiment, the replied text message may be transmitted via the data packet channel. Alternatively the replied text message may be transmitted via an email. The email may be encrypted using an encryption mechanism. In addition, the replied text message may include an alternative callback phone number other than the default phone number offered. Furthermore, the replied text message may provide an email address, which may be encrypted, to indicate the voicemails to be transmitted in a text format to the specified email address. Other information may be included in the replied text message.

In response to the replied text message, at processing block 1506, processing logic transmits the retrieved voicemails to the client in a manner specified by the client (e.g., either in a text format or in an audio format) using one of the aforementioned techniques.

Another Alternative Exemplary Extension

In one embodiment, the system can be extended to allow the telephony interface to autonomously launch calls to the predetermined destination device as determined by a set of predetermined criteria. For example, on calls from a specific Caller ID or user, in one embodiment, the JTS immediately calls the user's mobile device. This can be altered by a set of status information set from the mobile device in connectivity server 700, which can set the level of interruption allowed by the user. For example, only messages from certain caller ID numbers marked urgent will be automatically offered to the predetermined destination device. The system can be extended to allow the connectivity server 700 to also be provisioned with an SS 7 signaling protocol stack. This allows connectivity server 700 to determine information about offered calls to the user's station set from outside of the telephony switch. Such information can include the ID of the calling number and the time the call was offered.

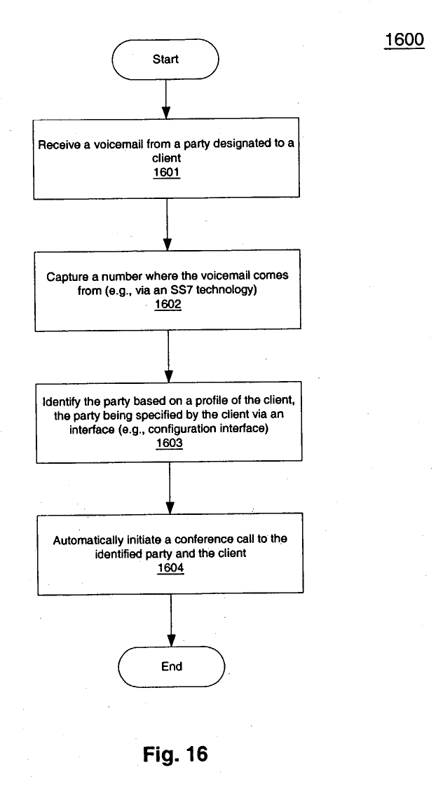

FIG. 16 is a flow diagram of an embodiment of a process for managing voice messages. The process is performed by processing logic which may comprise hardware (e.g., circuitry, dedicated logic, etc.), software (such as run on a general purpose computer system or a dedicated machine), or a combination of both. In one embodiment exemplary process 1600 may be performed by message management system 1301 of FIG. 13. In one embodiment, exemplary process 1600 includes identifying a voicemails received from a predetermined party, the voicemails designated to a client, and automatically initiating a conference call to the predetermined party and the client.

Referring to FIG. 16, at processing block 1601, processing logic receives a voicemails from a party designated to a client. At processing block 1602, processing logic captures a call number where the voicemails comes from. In one embodiment, the calling number may be captured using an SS7 technology. Alternatively, if the calling number cannot be captured (e.g., the calling party is using a caller ID blocker), the calling number may be extracted from the contents of the voicemails using one of the aforementioned techniques. At processing block 1603, processing logic identifies the calling party based on a profile of the client, which may be specified by the client via an interface (e.g., configuration unit 1004 of FIG. 10). At processing block 1605, processing logic automatically initiates a conference call (e.g., via Elix system) hosting both the identified party and the client, such that the identified party and the client can communicate (via the system, such as the connectivity server) over the conference call. In this embodiment, if the identified party and the client have a calling plan with free incoming calls, the conference call will be free of charge to the identified party and the client.

Alternatively, according to another embodiment, processing logic may initiate a conference call to the calling party and the client based on one or more predetermined keywords, such as “urgent”, within the voicemails. Such keywords may indicate a higher priority of the message that requires processing logic to immediately launch such conference call. In one embodiment, an ASR system may be utilized to recognize such keywords.

Although the above descriptions have described some embodiments of voice message management. It will be appreciated that other features regarding to voice messages apparent to one with ordinary skill in the art may be included. For example, according to one embodiment, connectivity server 1000 of FIG. 10 may include capabilities to receive one or more text messages, such as emails, dedicated to a client from email interface 1007 and forward the text messages to telephony interface or other processing units to transform the text messages into a speech using a synthesis text-to-speech (TTS) techniques. The connectivity server may then transmit a text message to client's mobile device over a data packet channel offering a call to a predetermined number to play the text messages in an audio format. This is particularly useful when a client is unable to access his/her email while the client is able to access to a telephony network. Other configurations may exist.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method for voice message control, the method comprising:
recognizing at least one recipient and a subject matter of one or more audio files stored in a storage facility;
generating a text message representing the subject matter of the one or more audio files; and
transmitting the text message to the at least one identified recipient over a packet data network channel without transmitting the contents of the one or more audio files.

2. The method of claim 1, further comprising:
capturing the one or more audio files from a remote client; and
storing the captured audio files in the storage facility.

3. The method of claim 1, wherein the text message comprises a menu of selectable options with respect to the audio files.

4. The method of claim 1, further comprising:
receiving a selection of one or more audio files to be played over one of a packet channel and a network environment;
calling a predetermined number to establish a voice connection; and
playing the one or more selected audio files over the voice connection.

5. The method of claim 1, further comprising:
receiving a selection of one or more audio files to be played over a packet channel; and
providing audio associated with the selected one or more audio files via the packet channel as packetized voice.

6. The method of claim 1, wherein identifying the one or more recipients and recognizing the subject matter are performed via one or more keywords within the one or more audio files.

7. The method of claim 1, wherein identifying the one or more recipients and recognizing the subject matter are performed via a template when the one or more audio files are captured.

8. The method of claim 1, further comprising:
transcribing substantially the entire one or more audio files into one or more text messages corresponding to the one or more audio files respectively; and
storing the one or more text messages in the storage facility.

9. The method of claim 8, wherein the transcribing the selected audio files is performed via a speech recognition system.

10. The method of claim 8, further comprising:
receiving a selection of one or more audio files to be played;
determining a preference of the one or more recipients;
transmitting the one or more text messages corresponding to the selected audio files to the one or more recipients, if the selected audio files are preferred to be in a text fromat.

11. The method of claim 10, wherein the preference is determined based on the selection received.

12. The method of claim 10, wherein the preference is determined based on a profile corresponding to the one or more recipients stored in the storage facility.

13. The method of claim 10, wherein the preference is determined based on whether the respective recipient device is able to receive information in an audio format.

14. The method of claim 10, wherein if the selected audio files are preferred to be played in an audio format, the method further comprises:
establishing an audio connection with the one or more recipients; and
playing the selected audio files over the audio connection.

15. The method of claim 10, wherein if the selected audio files are preferred to be played in an audio format, the method further comprises:
transmitting the selected audio files in a digital form to the at least one recipient over a network, the digital audio files being suitable to be played using a digital audio player.

16. A method for voice message control, the method comprising:
receiving a request for retrieving one or more voicemails from a remote client over a data packet channel;
determining a preference of the remote client; and
transmitting the one or more voicemails in a manner according to the preference of the remote client, the manner including one of an audio format and a text format.

17. A method for voice message control, the method comprising:
receiving a signal from a remote client over a data packet channel;
retrieving voicemails statuses from a plurality of voicemails systems in response to the signal; and
transmitting the voicemails statuses in a text format to the remote client over the data packet channel.

18. The method of claim 17, further comprising displaying the voicemails statues as a selectable menu corresponding to the status of each voicemails system.

19. The method of claim 18, further comprising:
receiving a selection of one or more voicemails systems among the plurality of voicemails systems over the data packet channel; and
retrieving voicemails from the selected one or more voicemails systems.

20. The method of claim 19, further comprising:
establishing an audio connection with the remote client; and
playing the voicemails from the selected one or more voicemails systems over the audio connection.

21. The method of claim 20, wherein the audio connection is established by calling a predetermined number of the remote client.

22. The method of claim 19, further comprising:
transcribing substantially the entire retrieved voicemails into a text message; and
transmitting the text message to the remote client.

23. A method for voice message control, the method comprising:
periodically monitoring status of a plurality of voicemails systems with respect to a client;
retrieving new voicemails from at least one of the plurality of voicemails systems in response to the status;
storing the new vorcenails as audio files in a storage facility; and
transmitting a first text message to notify the client regarding the new voicemails.

24. The method of claim 23, wherein the first text message is transmitted via an email.

25. The method of claim 23, wherein the first text message includes a subject matter representing each of the voicemails which are identified by a respective message number.

26. The method of claim 23, further comprising offering, within the first text message, a call to a predetermined callback number of the client to play at least one voicemails.

27. The method of claim 26, further comprising encrypting the predetermined callback number within the first text message via an encryption mechanism.

28. The method of claim 23, further comprising:
receiving a second text message from the client in response to the first text message, the second text message identifying at least one of the voicemails;
establishing a voice connection with the client; and
playing the identified one or more voicemails over the voice connection.

29. The method of claim 28, wherein the voice connection is established by calling a callback number specified by the client.

30. The method of claim 29, wherein the callback number is a predetermined number based on a profile of the client stored in a storage facility.

31. The method of claim 29, wherein the callback number is specified by the client within the second text message.

32. The method of claim 31, wherein the callback number is encrypted using an encryption mechanism within the second text message.

33. The method of claim 23, further comprising:
receiving a second text message from the client in response to the first text message, the second text message identifying at least one of the voicemails;
transcribing substantially the entire identified one or more voicemails into a third text message; and
transmitting the third text message to the client.

34. The method of claim 33, wherein the second text message is received via a data packet channel and the third text message is transmitted via an email.

35. A method for voice message control, the method comprising:
periodically monitoring status of a plurality of voicemails systems with respect to a client;
retrieving new voicemails from at least one of the plurality of voicemails systems in response to the status;
transcribing the new voicemails into text messages corresponding to each of the new voicemails; and
transmitting the text messages to the client.

36. A method for voice message control, the method comprising:
identifying a voicemails received from a predetermined party, the voicemails designated to a client; and
automatically initiating a conference call hosting the predetermined party and the client.

37. The method of claim 36, further comprising capturing a callback number of the predetermined party when the voicemails is received.

38. The method of claim 37, wherein the callback number of the predetermined party is captured using an SS7 technology.

39. The method of claim 36, wherein the predetermined party is specified by the client via an interface.

40. The method of claim 36, wherein the conference call to the client is initiated by calling a predetermined number according to a profile of the client.

41. The method of claim 36, further comprising examining contents of the voicemails to determine whether to initiate the conference call.

42. An apparatus for voice message control, the apparatus comprising:
means for recognizing at least one recipient and a subject matter of one or more audio files stored in a storage facility;
means for generating a text message representing the subject matter of the one or more audio files; and
means for transmitting the text message to the at least one identified recipient over a packet data network channel without transmitting the contents of the one or more audio files.

43. An apparatus, comprising:
a server; and
a voicemails system coupled to the server via a telephony interface,
wherein the server recognizes at least one recipient and a subject matter of one or more audio files stored in a storage facility, generates a text message representing the recognized subject matter, and transmits the text message to the at least one identified recipient over a packet data network channel without transmitting the contents of the one or more audio files.

44. The apparatus of claim 43, wherein the server comprises:
a storage;
a message router to receive one or more voicemails and to store the one or more voicemails in the storage; and
a telephony interface to identify the at least one recipient, to recognize the subject matter of the one or more voicemails, and to generate the text message which is transmitted by the message router to the identified recipient.

45. An apparatus for voice message control, the apparatus comprising:
means for receiving a request for retrieving one or more voicemails from a remote client over a data packet channel;
means for determining a preference of the remote client; and
means for transmitting the one or more voicemails in a manner according to the preference of the remote client, the manner including one of an audio format and a text format.

46. An apparatus for voice message control, the apparatus comprising:
means for receiving a signal from a remote client over a data packet channel;
means for retrieving voicemails statuses from a plurality of voicemails systems in response to the signal; and
means for transmitting the voicemails statuses in a text format to the remote client over the data packet channel.

47. An apparatus, comprising:
a server; and
a voicemails system coupled to the server via a telephony interface,
wherein the server receives a signal from a remote client over a data packet channel, retrieves voicemails status from the voicemails systems in response to the signal, and transmits the voicemails statuses in a text format to the remote client over the data packet channel.

48. An apparatus for voice message control, the apparatus comprising:
means for periodically monitoring status of a plurality of voicemails systems with respect to a client;
means for retrieving new voicemails from at least one of the plurality of voicemails systems in response to the status;
means for storing the new voicemails as audio files in a storage facility; and
means for transmitting a text message to notify the client regarding the new voicemails.

49. An apparatus, comprising:
a server; and
a voicemails system coupled to the server via a telephony interface,
wherein the server periodically monitors status of the voicemails system with respect to a client, retrieves new voicemails from the voicemails system in response to the status, stores the new voicemails as audio files in a storage facility, and transmits transmitting a text message to notify the client regarding the new voicemails.

50. An apparatus for voice message control, the apparatus comprising:
means for periodically monitoring status of a plurality of voicemails systems with respect to a client;
means for retrieving new voicemails from at least one of the plurality of voicemails systems in response to the status;
means for transcribing the new voicemails into text messages corresponding to each of the new voicemails; and
means for transmitting the text messages to the client.

51. An apparatus for voice message control, the apparatus comprising:
means for identifying a voicemails received from a predetermined party, the voicemails designated to a client; and
means for automatically initiating a conference call to the predetermined party and the client.

52. An apparatus, comprising:
a server; and
a voicemails system coupled to the server via a telephony interface,
wherein the server identifies a voicemails in the voicemails system received from a predetermined party, the voicemails designated to a client, and automatically initiates a conference call to the predetermined party and the client.
